(19) United States
(12) Patent Application Publication
(10) Pub. No.: US 2003/0083911 A1
(43) Pub. Date: May 1, 2003

(54) Method of ensuring audit integrity in e-supply chain

(76) Inventors: Jeremy John Carroll, Bristol (GB); James Clough, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/983,636

(22) Filed: Oct. 25, 2001

(51) Int. Cl. G06F 17/60

(52) U.S. Cl. 705/7

(57) ABSTRACT

A method is described of ensuring audit integrity in a supply chain for services requested by one node from another in a distributed network of computers, such nodes including an e-service provider and a plurality of product suppliers. The method particularly relates to the supply of a product which utilises valuable data for its production, and contains a negotiating phase for negotiating with at least one of the product suppliers for the production of the product and selecting a product supplier to produce and supply the product. In the negotiating phase, there is provision to the product suppliers of data address reference information relating to the location of the valuable data without the supply of the data to any of the product suppliers. The method also includes a production and supply phase in which the selected product supplier produces or arranges to produce the product and to supply the product, and the valuable data is provided in response to a request for the data. The method including logging the and any other request for the valuable data. The method may also include an order phase in which an order enquiry from a consumer is accepted for supply of such a product.

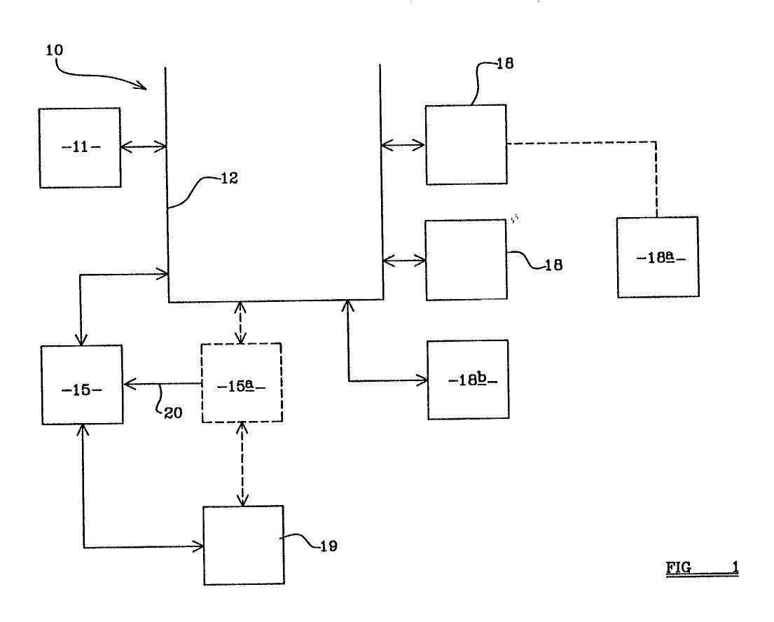

### BACKGROUND TO THE INVENTION

This invention relates to method of ensuring audit integrity in an e-supply chain in which in response to an order enquiry from a consumer, an e-service negotiates with at least one and usually a plurality of product suppliers for the production and supply of the products, and as a result of such negotiation the e-service selects a product supplier. More particularly the invention relates to an e-service which controls the supply of valuable data which is required by the selected product supplier to produce the product.

In this context an “e-service” is a service provided in association with a request sent by one node in a network of distributed computers to another node. This network of distributed computers will most often be the public internet, but other networks, both public and private, may be equally suitable. In this sense, a “computer” may be considered to be any apparatus with processing capability and the means to communicate with other computers through an appropriate communications network. In such an e-service, there will typically be an arrangement for payment to the service provider associated with the request for service. An “e-supply chain” will exist when fulfilment of an e-service requires the e-service provider to obtain an e-service from another.

For example the product may be a printed product, data for which is controlled by the e-service and is required by a product supplier in order to print the product. In another example the data may be required otherwise for processing by the product supplier, in order to produce the product. Thus the data is valuable in that the data is required to produce the product. The data typically would have associated intellectual property rights.

### DESCRIPTION OF THE PRIOR ART

Conventionally, during the negotiations between the e-service and potential product suppliers, the valuable data is supplied by the e-service to the potential product suppliers. Thus there is a risk that such valuable data may be misappropriated.

It is also known to pass an address reference to the valuable data to a potential product supplier in the supply chain so that at will, the valuable data may be requested and retrieved from the address referenced. However this affords no facility for the supply of the valuable data to be audited and accordingly there is again risk of the data being misappropriated.

### SUMMARY OF THE INVENTION

According to one aspect of the invention we provide a method of ensuring audit integrity in an e-supply chain including a consumer, an e-service provider and a plurality of product suppliers, the method including in an order phase accepting an order enquiry from a consumer for the supply of a product which utilises valuable data for its production, and in a negotiating phase negotiating with at least one of the product suppliers for the production of the product and selecting a product supplier to produce and supply the product, and in the negotiating phase, providing to the product suppliers, data address reference information relating to the location of the valuable data without supplying the data to any of the product suppliers; and in a production and supply phase in which the selected product supplier produces or arranges to produce the product and to supply the product, providing the valuable data in response to a request for the data, and the method including logging the and any other request for the valuable data.

Thus by performing the method of the invention, the valuable data is only provided in response to a specific auditable request for the data. Each product supplier with whom the e-service negotiates will of course have the capability of requesting and retrieving the valuable data from the data address reference information, but if they do so, such request will be logged and thus auditable.

For example if an e-service provider places an order with a single selected product supplier for the supply of a product but logs the receipt of more than a single request for the data, the e-service provider will know that the valuable data has been misappropriated, and by logging the requests, the identity of the unauthorised requester may be discovered.

The order enquiry from the consumer may include a job ticket relating to the consumer's preferences for the product. The method may include during the negotiating phase, supplying job ticket information including a transaction identifier, at least some of the consumer's preferences, and information relating to the product to be produced, to the potential product suppliers to facilitate meaningful negotiations. Thus sufficient information is supplied to each of the potential product suppliers for the product supplier, for example, to give a quotation and time estimation for producing and supplying the product, and any other information required by the e-service provider as part of the negotiations.

The data address reference information may include a uniform resource locator (URL) from which the address location of the data is provided to the product suppliers, and when a request is received for the valuable data, an identifier of the requester may be logged. Such an identifier is preferably a uniform resource identifier (URI) as defined in RFC 2396 of the Internet Engineering Force.

Particularly where the product is a printed product, the valuable data may be supplied to a requester as a binary large object so that optimum print quality for the image may be obtained.

According to a second aspect of the invention we provide a method of ensuring audit integrity in an e-supply chain including an e-service provider and a plurality of product suppliers, the method including an order phase in which a consumer makes an order enquiry to the e-service provider for the supply of a product which utilises valuable data for its production, a negotiating phase in which the e-service provider negotiates with at least one of the product suppliers for the production of the product; and a production and supply phase in which a selected product supplier produces or arranges to produce the product and to supply the product, and wherein during the negotiating phase the e-service provider provides to the product suppliers data address reference information relating to the location of the valuable data without supplying the data to any of the product suppliers, and for the supply phase, the selected product supplier requesting and retrieving the valuable data from the data address reference information, and the method including logging every request for the valuable data.

### BRIEF DESCRIPTION OF THE DRAWING

The invention will now be described with reference to the accompanying drawing which is a schematic view of an e-service operated by the method of the invention.

### DETAILED DESCRIPTION OF THE PREFERRED EMBODIMENTS

Referring to the drawing an e-service 10 includes a consumer 11 connected via a network connection to a network 12 such as the Internet, an Intranet, Virtual Private Network for examples only. An e-service provider 15 also connected via a network connection to the network 12, and a plurality of product suppliers 18, also are each connected to the network 12 via respective network connections.

For the purposes of illustration, in this example of the invention, the e-service 15 is part of a supply chain which provides products being poster prints to consumers 11 in response to orders from consumers received over the network 12. The consumer 11 may be connected to the network 12 via a personal computer or an alternative network enabled device.

Each of the product suppliers 18 are capable of producing poster prints when supplied with the necessary data, and supplying the prints, e.g. using the services of a delivery service, to consumers 11. If desired, in a more complex supply chain than that shown, the product suppliers 18 may choose to sub-contract the production work but negotiate directly with the e-service 15 as hereinafter explained, or act as proxy for a downstream supply chain product supplier, e.g. as indicated at 18a in dotted lines in the figure.

The product, in this case a poster print, requires data for its production. The data may be held by the e-service provider 15, or remotely, as indicated in dotted lines at 15a. The data i.e. intellectual property rights in the data, may thus be owned by the e-service provider 15, or by another party, with the data being supplied as hereinafter explained, by the e-service provider 15 or remote party 15a.

Whatever the product, e.g. poster print or other product which requires data for its production, the data required for its production is valuable data over which the owner of the data will wish to maintain some control. However in order that the e-service can offer a large amount and ever changing portfolio of data and freely negotiate with product suppliers, it is not desirable to erect secure individual security barriers such as password accesses for every item of data and for every transaction which would prevent the valuable data being accessed by other than a selected product supplier.

In accordance with the invention during an order phase of an e-service transaction, the consumer 11 places an order enquiry with the e-service provider 15. For example the consumer 11 may have viewed a low resolution image on the e-service supplier's 15 website and the consumer 11 may wish to obtain a high resolution poster print of the image. Thus the consumer initiates an order enquiry for the production and supply of the poster print.

Whereas the e-service supplier 15 may offer only a single choice of poster print, desirably, the consumer 11 is able to select preferences for the product. For example the consumer may be able to choose between different sized poster prints; different qualities of paper of other substrate, whether the poster print is framed or not and if framed, there may be a choice of frames, and the delivery schedule. Thus the e-service provider 15 would require the consumer to indicate such preferences in order to create a job ticket for the product. Typically the e-service provider 15 contracts with the consumer for the production and supply of the required poster print with the consumer's preferences at a fixed price, but in a more complex e-service, more complex two-way negotiations may occur. In response to either an order enquiry or subsequently when an order is placed by the consumer 11 following an order enquiry, the e-service provider 15 negotiates with at least some of the product suppliers 18, for the production and supply of the product.

Typically, the e-service provider 15 broadcasts to each of the product suppliers 18 an initial negotiating message. In accordance with the invention, such message does not include the valuable data relating to the ordered product, but data address reference information relating to the location of the valuable data, and job ticket information. The data address information may include a URL where the data is located, including for example transaction identifier information so that any request for the data later made, can be related to a particular transaction i.e. consumer order. Such data address information may for example be in the format HTTPS://(address)/(image name)? (transaction ID).

The job ticket information may include information relating to the image to be printed, such as the image resolution, number of colours etc. and the consumer's preferences. If desired the job ticket information may also include the transaction identifier information. Further alternatively, the job ticket could include image data relating to the image to be printed, for example a low resolution of thumbnail image for ease of identification purposes where there is any human interaction, but not the valuable data necessary for the high resolution poster print to be produced

In response to such message, each of the product suppliers 18 who wish to negotiate to produce and supply the product may respond. Of course any product supplier 15 may decline to respond, if for example the product supplier 15 has no capacity to produce and supply the product.

The response for the or each product supplier 15 may take the form of a simple quotation for the production and supply of the product, or may indicate one or more alternative quotes for a modified job ticket. For example the consumer 11 may have indicated a preference for one quality of paper and the product supplier may give a quotation or alternative quotation for the product printed on an alternative higher or lower grade paper.

Where there is the possibility of further negotiation between the e-service supplier 15 and the consumer at this stage, a response from the e-service provider 15 to the consumer 11, taking into account the nature of one or more of the product suppliers' responses, may be communicated to the consumer 11 for the consumer 11 to consider modifying the consumer's preferences.

When 11 consumer confirms an order according to the consumer's originally indicated or modified preferences, the e-service provider 15 confirms an order with a selected product supplier 18 for the production and supply of the product. The consumer 11 may pay the e-service provider 15 for the product e.g. by credit card on an individual order basis, or the consumer may hold an account with the e-service provider 15.

The selected product supplier 18 is most likely to be selected by the e-service provider 15 on price where the product suppliers' 18 terms are otherwise comparable.

The product suppliers 18 may, in the course of the negotiation phase of the transaction, have themselves negotiated for example with several delivery services to find the most competitive price for the delivery of the product which will be charged by delivery services to the product suppliers 18, or the product suppliers 18 may even negotiate with sub-contractors for the production of the product.

In each case, after the negotiation phase, the transaction enters a production and supply phase during which the selected product supplier produces and arranges to deliver the ordered product to the consumer 11. However in accordance with the invention the selected product supplier, say the product supplier indicated at 18b in the figure, does not yet have the necessary valuable data to produce the product, but only the data address reference information relating to the location of the valuable data. The selected product supplier 18b thus needs to make a request for the valuable data at the relevant location, in order to retrieve the data.

In this example where the data is held in a database 19 by the e-service provider 15 itself, the request is made to HTTPS://(address)/(image name)? (transaction ID), and as a result the valuable data may be retrieved. The selected product supplier's 18b request is logged i.e. recorded by the e-service provider 15 for audit purposes, and accordingly the e-service provider 15 will know that the valuable data has been retrieved by the selected product supplier 18b for the purposes of the particular transaction identified. Auditing is facilitated by the inclusion in the transaction identifier ID in the data address reference information, and by selected product supplier's 18b uniform resource identifier (URI) for example, or other identifier, being logged.

Thus the supply of data is audited ensuring audit integrity in the e-supply chain.

Because the broadcast message to the potential product suppliers 18 during the negotiating phase of the transaction includes data address reference information, and because each of the product suppliers 18 are approved suppliers to the e-service provider and have access to the valuable data, any of the product suppliers 18 could make a request for and hence retrieve the valuable data, but any such request will be logged by the e-service provider 15 and the identity of the requester established. Thus any unauthorised data retrieval can be policed.

In the event that the valuable data is held remotely of the e-service provider, e.g. in a database 19 on a remote server as indicated in dotted lines in the figure at 15a, any request for data needs to be made to that server 15a. The server 15a rather than the e-service provider 15 would in this case log requests for retrieval of data from the server 15a, and logging information to enable the e-service provider 15 to become aware of unauthorised data retrievals, may be communicated to the e-service provider 15 directly as indicated by communication line 20 in the figure, or more usually over the network 12.

In this example, where the product is a printed product, the valuable data may be supplied to a requester as a binary large object so that optimum print quality for the image may be obtained. However in an alternative embodiment where the product is for example information obtained by processing the valuable data, the data may be supplied in other appropriate formats.

If desirable the invention may be used in conjunction with other security measures which help prevent the valuable data being generally accessed.

For example the address information may include a long random string of integers to make it less likely that particular valuable data could be accessed without the address information being provided.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A method of ensuring audit integrity in a supply chain for services requested by one node from another in a distributed network of computers, such nodes including a consumer, an e-service provider and a plurality of product suppliers, the method including in an order phase accepting an order enquiry from a consumer for the supply of a product which utilises valuable data for its production, and in a negotiating phase negotiating with at least one of the product suppliers for the production of the product and selecting a product supplier to produce and supply the product, and in the negotiating phase, providing to the product suppliers, data address reference information relating to the location of the valuable data without supplying the data to any of the product suppliers; and in a production and supply phase in which the selected product supplier produces or arranges to produce the product and to supply the product, providing the valuable data in response to a request for the data, and the method including logging the and any other request for the valuable data.

2. A method according to claim 1 wherein the order enquiry from the consumer includes a job ticket relating to the consumer's preferences for the product, and the method includes during the negotiating phase, supplying job ticket information including a transaction identifier, at least some of the consumer's preferences, and information relating to the product to be produced, to the potential product suppliers to facilitate meaningful negotiations.

3. A method according to claim 1 wherein the data address reference information includes a URL of the address location of the data.

4. A method according to claim 3 wherein the data address reference information includes a transaction identifier.

5. A method according to claim I wherein when any request is received for the valuable data, the URL of the requester is logged.

6. A method according to claim 1 wherein the product is a printed product, and the method includes supplying the valuable data to a requester as a binary large object so that optimum print quality for the image may be obtained.

7. A method of ensuring audit integrity in a supply chain for services requested by one node from another in a distributed network of computers, said nodes including a service provider and a plurality of product suppliers, the method including an order phase in which a consumer makes an order enquiry to the service provider for the supply of a product which utilises valuable data for its production, a negotiating phase in which the service provider negotiates with at least one of the product suppliers for the production of the product; and a production and supply phase in which a selected product supplier produces or arranges to produce the product and to supply the product, and wherein during the negotiating phase the service provider provides to the product suppliers data address reference information relating to the location of the valuable data without supplying the data to any of the product suppliers, and for the supply phase, the selected product supplier requesting and retrieving the valuable data from the data address reference information, and the method including logging every request for the valuable data.
